(19) United States
(12) Patent Application Publication
(10) Pub. No.: US 2004/0258224 A1
(43) Pub. Date: Dec. 23, 2004

(54) Telephone Fax, Keyboard

(76) Inventor: Warren Jeffrey Player, Hudson, OH (US)

Correspondence Address: WARREN JEFFREY PLAYER, 2036 MARWELL BLVD, Hudson, OH, 44236, US

(21) Appl. No.: 10/102,114

(22) Filed: Aug. 5, 2002

(51) Int. Cl. H04M 11/00

(52) U.S. Cl. 379/100.01

(57) ABSTRACT

1) FIG. 2 Function Key Button to activate Floppy Disk Drive software installation

2) FIG. 3 Function Key Button for sending Faxes

3) FIG. 4 Function Key Button for stopping Faxes

4) FIG. 5 Input-Auxiliary Speaker Jack

5) FIG. 6 Input-Auxiliary Headset Jack

6) FIG. 7 Input-Auxiliary Microphone Jack

7) FIG. 8 Output RJ-11 Phone Line

8) FIG. 9 Output-RJ-11 Fax Line

9) FIG. 10 Speaker Intercom

10) FIG. 11 Adjustable LCD Screen Housing

11) FIG. 12 Number and Text LCD Display Screen

12) FIG. 13 Intercom Speaker Volume Control Button

14) FIG. 14 Phone line transfer extension buttons

15) FIG. 15 Built-in Telephone Terminal with telephone alpha numeric keypad

16) FIG. 16 Voice Recognition Microphone w/on/off switch

17) FIG. 17 Receiver or Phone flash button

18) FIG. 18 Full Size Keyboard Housing Assembly

### FIELD OF THE INVENTION

The invention relates to keyboards and is particularly concerned with keyboards for use with built in faxing capabilities and telephone communication.

### BACKGROUND OF THE INVENTION

the outside. The keyboard on the right outer edge is a telephone terminal. The keyboard is a standard keyboard for use with the personal computer. This patent only contemplates the user dialing a telephone number at in any event, even if it is possible to use the telephonefax, keyboard to dial a telephone number when the flap is opened, it would likely be awkward. As well, since this device incorporates a personal computer having a complete 101 key standard computer peripheral keyboard, the device is larger and therefore more bulky than many current standard size keyboards, or at least, 101 keys standard size keyboards, as well as having a greater depth dimension. Moreover, the telephone mouthpiece and earpiece on this device are on of the lower backside of the keyboard, resulting in a telephone that is less comfortable to hold than a standard telephone and creating a less aesthetically pleasing device than many current telephones.

The fax device is located on the outer surface of the telephone fax, keyboard. When start button is activated a fax application is executed and sends the word processor document to the fax machine, from the telephonefax, keyboard. When the stop button is activated the fax is retrieved and blocked from destination to fax machine, an outer face telephone terminal which is the main body of the telephone built into right side of keyboard allows the user to access to all out bound and in bound phone calls.

### SUMMARY OF THE INVENTION

It is an object of the invention is to obviate or mitigate one or more of the above- identified disadvantages.

Telephone fax, Keyboard—invention is a computer peripheral keyboard that has faxing & telephone communication calling in-bound and out-bound capabilities. Telephone Fax, Keyboard will allow the end-user to send faxes directly to the fax machine and PC and also receive faxes electronically to the Telephone Fax, Keyboard directly from fax machine and PC. Generally call centers, telemarketing and banking intuitions firms can have a real significant use of the telephone fax, keyboard computer peripheral keyboard for customer service needs or telemarketing contact sales. The Telephone Fax, Keyboard has a built-in telephone Terminal with telephone alpha numeric keypad with an adjustable LCD number and text display screen for caller ID.

According to a first broad aspect, the invention provides a portable telephone comprising a body and a flap hinged near a lower edge of the body, the flap having a closed position against the body and an open position, the flap having an outer keyboard on an outer surface of the flap, allowing a user to dial telephone numbers by pressing keys on the outer keyboard when the flap is in the closed position and the flap further having an inner keyboard on an inner surface of the flap, allowing a user to dial telephone numbers by pressing keys on the inner keyboard when the flap is in the open position.

Advantages of the invention include allowing a user of a computer peripheral keyboard to make faxes while in word processing applications having the ability to have access to making phone calls from the telephonefax, keyboard whether all 101 keyboards keys are being utilized simultaneously or not.

### BRIEF DESCRIPTION OF THE DRAWINGS

Preferred embodiments of the invention will now be described with reference to the attached drawings in which

FIG. 1a is a front view of a stationary telephone terminal constructed and built in stationary to the right side of the keyboard according to the present invention.

FIG. 2 Function Key Button to activate CD-ROM Drive software installation

FIG. 3 Function Key Button to activate Floppy Disk Drive software installation

FIG. 4 Function Key Button for sending Faxes

FIG. 5 Function Key Button for stopping Faxes

FIG. 6 Input-Auxiliary Speaker Jack

FIG. 7 Input-Auxiliary Headset Jack

FIG. 8 Input-Auxiliary Microphone Jack

FIG. 9 Output RJ-11 Phone Line

FIG. 10 Output-RJ-11 Fax Line

FIG. 11 Speaker Intercom

FIG. 12 Adjustable LCD Screen Housing

FIG. 13 Number and Text LCD Display Screen

FIG. 14 Intercom Speaker Volume Control Button

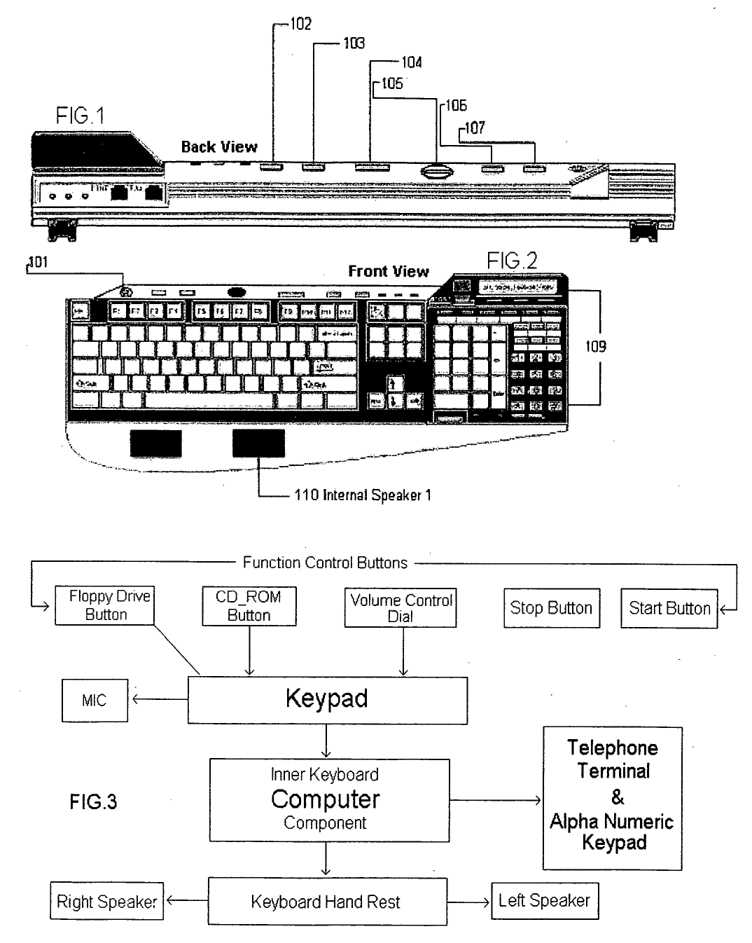

What I claim as my invention is:

1. Telephone Fax, Keyboard—Telephone Fax, Keyboard has a telephone terminal and telephone alpha numeric keypad and a LCD screen display-to-display phone numbers and text built into the right side of the keyboard next to the numeric keypad. Telephone Fax, Keyboard is equipped with two function button keys that will execute software installations directly from the PC's 3/12 floppy disk drive and CD-Rom drive. Telephone Fax, Keyboard is equipped with two function button keys: one function button for sending a fax and second function button for stopping a fax. Telephone Fax, Keyboard is equipped with two RJ-11 phone jacks side by side in back of the right side of the keyboard. Telephone Fax, Keyboard is equipped with a speaker for voice intercom conferencing. Telephone Fax, Keyboard is equipped with Auxiliary Input-Jack, Speaker Input-Jack, and Microphone Input-jack located ½″ on the back right hand side of the Telephone Fax, Keyboard of the two RJ-11 phone jacks. Telephone Fax, Keyboard is 20″ inches in length and 7/12″ inches by width. Telephone Fax, Keyboard is equipped with a receiver function button that will allow the end-user to disconnect from a call. Telephone Fax, Keyboard is equipped with a microchip that contains embedded fax software to send and receive faxes electronically from the keyboard. Telephone Fax, Keyboard is equipped with a USB port connection cable for data communication between the PC and the Telephone Fax, Keyboard peripheral.

2. The telephone terminal of claim 1, wherein from the right side of keyboard, the built in telephone terminal has alphanumeric key pad and pivotal liquid crystal LCD text and numeric display screen.

3. The telephone terminal of claim 1, wherein from the right side position of, the LCD Screen flap is pivotal more than 160 degrees to the front face position.

4. The telephone terminal of claim 1, wherein the telephone terminal has a receiver to receive and disconnect from caller.

5. A telephone terminal of claim 1 comprising a body and a flap hinged caller ID LCD display screen near a upper edge of the body telephone terminal and above alpha numeric phone dialer key-pad, the caller ID LCD display screen flap having a 160 degree pivotal position against the body and an tilt position, the flap having an outer keyboard on an outer surface of the caller ID LCD display screen flap, allowing a user to dial telephone numbers by pressing keys on the outer right side edge of the keyboard. Position and the flap further having an inner keyboard on an inner surface of the flap, allowing a user to dial telephone numbers by pressing keys on the outer right side of keyboard, wherein the caller ID LCD display screen flap further has a built in intercom speaker conferencing.

6. The telephone terminal of claim 1, wherein for most keys on the inner keyboard there is an identical corresponding key on the outer keyboard.

7. The telephone terminal of claim 1, wherein the number of keys and configuration of keys on the inner keyboard and right outer keyboard are alphanumeric push buttons.

8. The telephone terminal of claim 1, wherein underneath alphanumeric keypad is microphone for communication with caller.

9. The telephone terminal of claim 1, wherein telephone terminal has a microchip to convert analog to digital or cellular signal.

10. The fax device of claim 2, wherein the telephone further comprises a sensing device for determining when the start button is in the push position and the fax device is activated, when the faxing device determines that the word processor document is sent to a fax machine the fax device is deactivated.

11. The fax device of claim 2, wherein the start button further comprises a means for sending any word processing document and wherein the fax machine receives the fax from the telephone fax, keyboard.

12. The fax device of claim 2, wherein the stop button further stops all faxes after the start button is activated and a fax is sent to fax machine or any fax recipient.

13. The telephone terminal of claim 1, wherein the telephone terminal further comprises a rigid printed wiring board comprising a first set of circuitry on one side underlying the inner keyboard.

14. A telephone terminal of claim 1, a telephone terminal body, wherein position of right side outer keyboard on an outer surface of keyboard, allowing a user to dial telephone numbers by pressing alphanumeric buttons and LCD display screen on the right outer edge of keyboard further having an inner keyboard on an left inner surface of the telephone terminal, wherein comprises a rigid printed wiring board comprising a first set of circuitry on one side underlying the inner keyboard.
